(19) United States
(12) Patent Application Publication
(10) Pub. No.: US 2002/0186626 A1
(43) Pub. Date: Dec. 12, 2002

(54) Method of controlling side push-pull balance in dual push-pull type tracking servo

(75) Inventors: Young-Hoon Lee, Seoul (KR); In-Wook Hwang, Gyeonggi-do (KR); Young-Ok Koh, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/166,643

(22) Filed: Jun. 12, 2002

(30) Foreign Application Priority Data
Jun. 12, 2001 (KR) 2001-32949

(51) Int. Cl. G11B 7/095

(52) U.S. Cl. 369/44.29; 369/44.28

(57) ABSTRACT

A method of controlling a side push-pull (SPP) balance in a dual push-pull (DPP) type tracking servo employing both a main push-pull (MPP) balance and the SPP balance includes rotating a disc without performing a tracking servo, periodically shifting a pickup from a track center to the right and left by a first distance, obtaining an SPP signal and low-pass filtering the SPP signal to obtain a DC component, and adjusting an offset of the SPP signal so that the DC component of the SPP signal is 0. Since the pickup is forcibly and periodically shifted from the track center to the right and left by the predetermined distance during an SPP balance control, the SPP balance control can be effectively performed even on a disc having little eccentricity.

### CROSS-REFERENCE TO RELATED APPLICATIONS

This application claims the benefit of Korean No. 2001-32949, filed Jun. 12, 2001, in the Korean Industrial Property office, the disclosure of which is incorporated herein by reference.

### BACKGROUND OF THE INVENTION

1. Field of the Invention

The present invention relates to a method of controlling a side push-pull (SPP) balance in a tracking servo, and more particularly, to a method of controlling a side push-pull (SPP) balance to remove a direct current (DC) component from an SPP signal in a dual push-pull (DPP) type tracking servo.

2. Description of the Related Art

Tracking means that an optical pickup exactly follows a track formed on an optical disc. In a conventional tracking method, main push-pull (MPP) and side push-pull (SPP) methods are used together by using a 6- or 8-division photodetector. This tracking method is referred to as a dual push-pull (DPP) method. The MPP method uses an MPP signal which is obtained by combining first optical signals obtained from, for example, four central light receiving devices of the 8-division photodetector, and the SPP method uses an SPP signal which is obtained by combining second optical signals obtained from the other four peripheral light receiving devices thereof.

It is essential to the DPP method to accomplish a balance of the MPP signal and the SPP signal when a pickup is deviated to the left of a track and to the right of the track. In other words, an offset generated between the MPP signal and the SPP signal that are measured when the pickup deviates to the left of the track center by a certain distance must be the same as the offset between the MPP signal and the SPP signal that are measured when the pickup deviates to the right of the track center by the certain distance.

In a conventional SPP balance control method, the SPP signal is obtained while the optical disc is rotated without performing a tracking servo, and an amplification degree (amount) of an amplifier which amplifies the SPP signal is controlled so that a direct current (DC) value (component) of the obtained SPP signal is 0.

An optical disc may have inherent eccentricity or extrinsic eccentricity due to a center mismatching (misalignment) between the optical disc and a clamping and rotating device. When the optical disc is rotated without performing the tracking servo, the SPP signal can be obtained from a tracking error component due to the eccentricity of the optical disc. An amount of the eccentricity of the optical disc occurs symmetrically in a left side and a right side of the track center when negative and positive values of the SPP signal are symmetric. Consequently, the DC component of the SPP signal is 0. Here, the DC component of the SPP signal is obtained by low-pass filtering the SPP signal.

The above described conventional method has a problem in that a balance accuracy is changed depending on the amount of the eccentricity. As the amount of the eccentricity increases, the number of tracks, which the pickup crosses, increases, thereby increasing a high frequency component of the SPP signal. In contrast, as the amount of the eccentricity decreases, the number of tracks, which the pickup crosses, decreases, thereby decreasing the high frequency component of the SPP signal. Actually, the high frequency component of the SPP signal is in a first frequency band of several KHz when the amount of the eccentricity is large but is in a second frequency band of several Hz when the amount of the eccentricity is small. This indicates that a cutoff frequency of a low-pass filter for obtaining the DC component of the SPP signal must be changed to be lower when the amount of the eccentricity is small than when the amount of the eccentricity is large. Moreover, in a case of a non-eccentric disc rarely having eccentricity, the high frequency component of the SPP signal is so little that the SPP balance control is impossible.

### SUMMARY OF THE INVENTION

To solve the above and other problems, it is an object of the present invention to provide an improved side push-pull (SPP) balance control method through which a SPP balance control can be effectively performed even on a non-eccentric disc.

Additional objects and advantageous of the invention will be set forth in part in the description which follows and, in part, will be obvious from the description, or may be learned by practice of the invention.

Accordingly, to achieve the above and other objects according to an embodiment of the present invention, there is provided a method of controlling a side push-pull (SPP) balance in a dual push-pull (DPP) type tracking servo employing both a main push-pull (MPP) method and an SPP method. The method includes rotating a disc without performing a tracking servo, periodically shifting a pickup from a track center to the right and left by a predetermined distance, obtaining an SPP signal and low-pass filtering the SPP signal to obtain a DC component, and adjusting an offset of the SPP signal so that the DC component of the SPP signal is 0. Since the pickup is forcibly and periodically shifted from the track center to the right and left by the predetermined distance during a SPP balance control, the SPP balance control can be effectively performed even on a disc having little eccentricity.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a flowchart showing a method of controlling a side push-pull (SPP) balance according to an embodiment of the present invention;

FIGS. 2A and 2B are waveform diagrams for explaining the method shown in FIG. 1;

FIGS. 3A and 3B are waveform diagrams for explaining another method of controlling the SPP balance according to another embodiment of the present invention;

FIG. 4 is a diagram of an 8-division photodetector; and

FIG. 5 is a diagram showing an amount of a shift of a pickup from a track center.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

Hereinafter, the configuration and operation of the present invention will be described in detail with reference to the attached drawings.

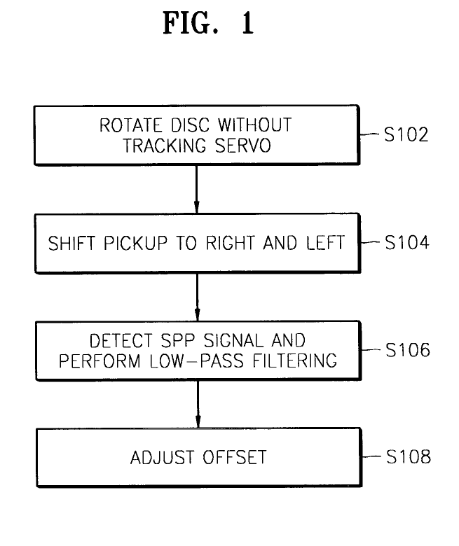

FIG. 1 is a flowchart showing a method of controlling a side push-pull (SPP) balance according to an embodiment of the present invention. The method of controlling the SPP balance is characterized by forcibly and periodically shifting a pickup from a track center to the right and left by a predetermined distance dl, as shown in FIGS. 1 and 5, in order to increase a high frequency component of an SPP signal. By forcibly and periodically shifting the pickup from the track center to the right and left by the predetermined distance dl, eccentricity is artificially provoked so that the SPP balance can be effectively controlled even on a non-eccentric disc.

A disc is rotated without performing a tracking servo in operation S102. Next, the pickup is periodically shifted from the track center to the right and left by the predetermined distance dl, as shown in FIG. 5, in operation S104. The SPP signal is obtained and low-pass filtered to obtain a DC component in operation S106. An offset of the SPP signal and a main push-pull (MPP) signal is adjusted such that the DC component is 0 in operation S108. In other words, an amplification degree (amount) of amplifiers (not shown) is adjusted to remove the offset between outputs of the amplifiers. One of the amplifiers amplifies first optical signals (the SPP signal) obtained from a first group of left peripheral light receiving devices, and the other one of the amplifiers amplifies second optical signals (the MPP signal) obtained from a second group of right peripheral light receiving devices, respectively, of a photodetector.

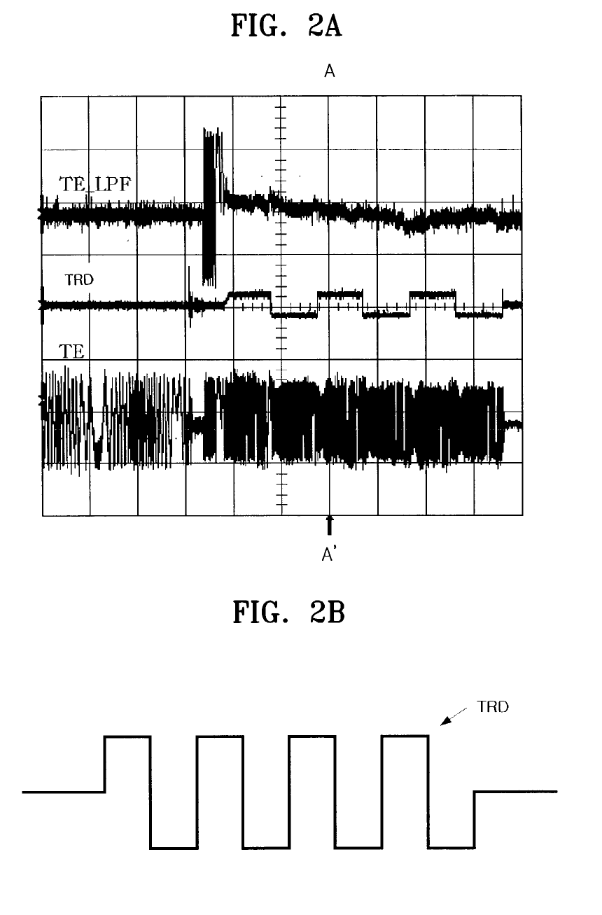

FIGS. 2A and 2B are waveform diagrams for explaining the method shown in FIG. 1. In FIG. 2A, a signal TE_LPF is a result of low-pass filtering a tracking error signal TE, and a signal TRD is an actuator driving signal to shift the pickup to the right and left of the track center. FIG. 2B is a detailed waveform diagram of the actuator driving signal TRD of FIG. 2A.

In FIG. 2A, a left portion of a line A-A′ shows that the actuator driving signal TRD is not applied to an actuator (not shown) of the pickup, and a right portion of the line A-A′ shows that the actuator driving signal TRD is applied to the actuator. It can be seen from a comparison between the tracking error signal TE and the actuator driving signal TRD that the high frequency component of the tracking error signal TE increases when the actuator driving signal TRD shown in FIG. 2B has a square wave, that is, when the pickup is shifted from the track center to the right and left. This results from an increase in the number of tracks that are crossed by the pickup that is forcibly shifted from the track center to the right and left by the distance dl. Here, it is possible to set the amplitude of the actuator driving signal TRD to shift the pickup from the track center by the distance d1. It is possible that the distance d1 is about 0.3 mm.

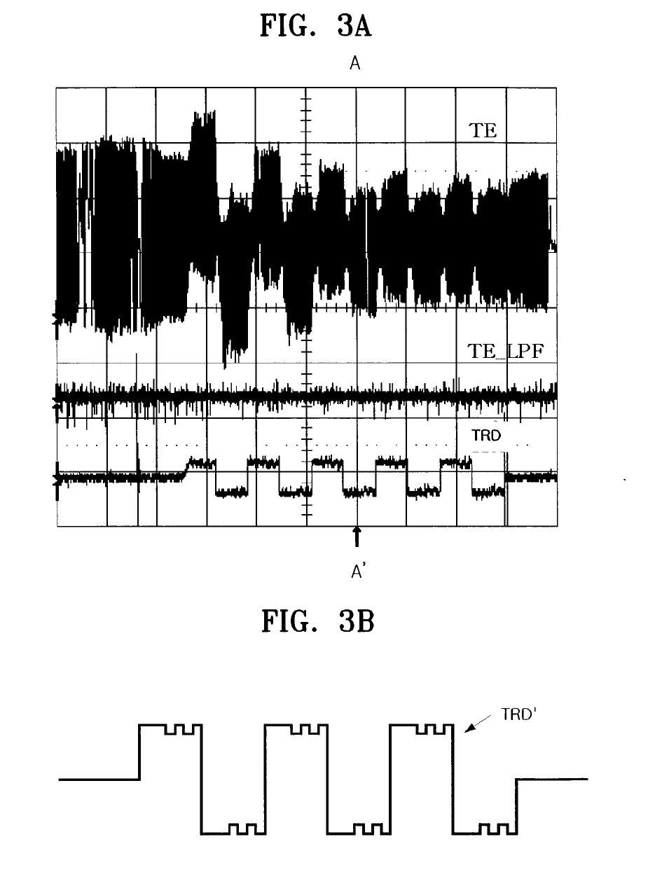

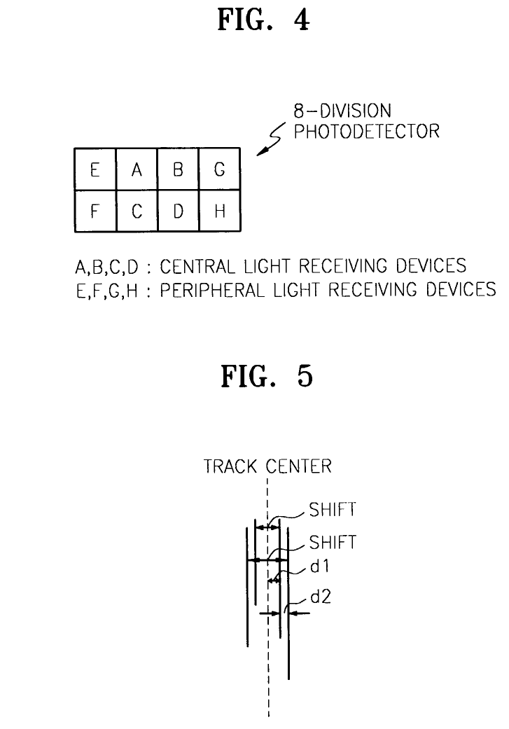

FIGS. 3A and 3B are waveform diagrams explaining another method of controlling the SPP balance according to another embodiment of the present invention. Although the method of FIG. 1 reduces a tracking error component, that is, a non-eccentric component, when the non-eccentric disc is reproduced, another method of FIGS. 3A and 3B is more satisfactory for a disc having little eccentricity. Accordingly, in another method of FIGS. 3A and 3B, a square-wave (rectangular-wave) component is added to the actuator driving signal TRD of FIGS. 2A and 2B to remove the non-eccentric component. In other words, as shown in FIG. 3B, a small square (rectangular) signal (the square-wave component) is added to a top portion and a bottom portion of the actuator driving signal TRD of FIG. 2B.

In FIG. 3A, a top waveform represents a tracking error signal TE, a middle waveform represents a signal that is a result of low-pass filtering the tracking error signal TE, and a bottom waveform represents a modified actuator driving signal TRD′. FIG. 3B is a detailed waveform diagram of the modified actuator driving signal TRD′ of FIG. 3A. It can be seen that the modified actuator driving signal TRD′ corresponds to the actuator driving signal TRD of FIG. 2B and has small-amplitude square waves at the top and bottom portions of the waveform thereof.

In FIG. 3A, a left portion of a line A-A′ shows that the modified actuator driving signal TRD′ is not applied to the actuator of the pickup, and a right portion of the line A-A′ shows that the modified actuator driving signal TRD′ is applied to the actuator. It can be seen from a comparison between the tracking error signal TE and the modified actuator driving signal TRD′ that the high frequency component of the tracking error signal TE increases more than that of FIG. 2A when the modified actuator driving signal TRD′ has the small square signal, that is, when the pickup is shifted from the track center to the right and left by a predetermined total distance d1+d2 as shown in FIG. 5. This results from a greater increase than that of FIG. 2A in the number of tracks that are crossed by the pickup that is forcibly initially shifted from the track center to the right and left to a first shifting position by the distance dl and second shifted to a second shifting position by a second distance d2. Here, it is possible to set an initial amplitude of the modified actuator driving signal TRD′ to shift the pickup from the track center to the first shifting position by about 0.3 mm and to set a secondary amplitude of the modified actuator driving signal TRD′ to shift the pickup from the first shifting position to a second shifting position by about 0.1 mm.

According to the SPP balance control method of the present invention described with reference to FIGS. 1 through 3B, the pickup is forcibly and periodically shifted from the track center to the right and left by the predetermined distance during the SPP balance control, thereby effectively performing the SPP balance control even on the optical disc having little eccentricity.

Unlike a conventional SPP balance control method, it is not necessary to adjust a cutoff frequency of a low-pass filter, which low-pass filters the SPP signal, depending on the amount of eccentricity of the track or the optical disc so that the SPP balance control can be easily performed.

In the above description, although a square wave is used as the actuator driving signal TRD, the present invention is not limited thereto. When considering that the actuator driving signal TRD is used to shift a pickup to the right and left, any signal allowing the pickup to be symmetrically shifted by an actuator can be used.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A method of controlling a side push-pull (SPP) balance in a dual push-pull (DPP) type tracking servo employing both a main push-pull (MPP) balance and the SPP balance, the method comprising:
rotating a disc without performing a tracking servo;
periodically shifting a pickup from a track center of the disc to a shifting position in a first direction or a second direction by a first distance;
obtaining an SPP signal and low-pass filtering the SPP signal to obtain a DC component; and
adjusting an offset of the SPP signal so that the DC component of the SPP signal is about 0.

2. The method of claim 1, wherein the first distance is 0.3 mm.

3. The method of claim 1, wherein the pickup is symmetrically shifted from the track center to the first and second directions.

4. The method of claim 1, wherein the shifting of the pickup comprises second shifting from the shifting position to a second shifting position by a second distance.

5. The method of claim 4, wherein the second distance is 0.1 mm.

6. A method in a dual push-pull (DPP) type tracking servo employing both a main push-pull (MPP) balance and a side push-pull (SPP) balance, the method comprising:
generating a signal to control a pickup to be shifted to opposite positions with respect to a track center of a track of a disc when a tracking servo is not performed to control the SPP balance.

7. The method of claim 6, further comprising:
moving the pickup to the positions by crossing the track center in a first direction and a second direction in response to the signal.

8. The method of claim 6, wherein the opposite positions comprise a first opposite position and a second opposite position disposed opposite to the first opposite position with respect to the track center, and the method further comprises:
moving the pickup from the first opposite position to the second opposite position.

9. The method of claim 6, further comprising:
periodically moving the pickup to the positions by crossing the track center in response to the signal to generate an artificial eccentricity of the track of the disc.

10. The method of claim 6, further comprising:
controlling the pickup to cross a number of tracks in response to the signal.

11. The method of claim 6, further comprising:
receiving an MPP signal from a first photo detector and an SPP signal from a second photo detector when the pickup is moved to the opposite positions in response to the signal; and
removing an offset between the MPP signal and the SPP signal to obtain a high frequency component.

12. The method of claim 11, wherein the removing of the offset comprises:
obtaining a direct current component from the SSP signal by low-pass filtering the SSP signal; and
removing the direct current component from the SSP signal.

13. The method of claim 6, wherein the generating of the signal comprises:
generating positive and negative signals to control the pickup to cross the track center in a first direction and a second direction being opposite to the first direction.

14. The method of claim 6, wherein the generating of the signal comprises:
generating rectangular signals having opposite polarities to control the pick to move in a first direction and a second direction being opposite to the first direction.

15. The method of claim 6, wherein the generating of the signal comprises:
generating a first signal to control the pickup to be shifted by a first distance from the track center and a second signal to control the pickup to be shifted by a second distance from the track center, the second distance being greater than the first distance.

16. The method of claim 15, wherein a difference between the first distance and the second distance is less than the first distance.

17. The method of claim 6, wherein the generating of the signal comprises:
generating a first signal to control the pickup to be shifted to a first position from the track center and a second signal to control the pickup to be shifted to a second position from the first position.

18. The method of claim 17, wherein the first signal is greater than the second signal in amplitude.

19. The method of claim 16, wherein the second signal has a time period smaller than that of the first signal.

20. The method of claim 16, wherein the second signal comprises a plurality of pulses generated during a pulse of the first signal.

21. The method of claim 16, wherein the first position is spaced-apart from the track center more than the second position.

22. The method of claim 16, wherein the first position comprises two first opposite positions disposed opposite to each other with respect to the track center.

23. The method of claim 22, further comprising:
moving the pickup between the two first opposite positions in response to the signal.

24. The method of claim 22, wherein the second position comprises two second opposite positions disposed opposite to each other with respect to the track center, and the method comprises:
moving the pickup between the two second opposite positions in response to the signal.

25. The method of claim 24, wherein the moving of the pickup comprises:
first-moving the pickup to one of the first opposite positions; and
second-moving the pickup from the one of the first opposite positions to one of the second opposite position disposed on the same side of the track center.

26. The method of claim 24, wherein the moving of the pickup comprises:
moving the pickup to one of the first opposite positions, one of the second opposite positions, the other one of the first opposite positions, and the other one of the second opposite positions in order.

27. The method of claim 24, wherein the moving of the pickup comprises:
moving the pickup to one of the first opposite positions; and
moving the pickup between one of the second opposite positions and the one of the first opposite positions.

28. The method of claim 27, wherein the moving of the pickup comprises:
moving the pickup to the other one of the first opposite positions by crossing the track center; and
moving the pickup to the other one of the second opposite positions.

29. A method in a dual push-pull (DPP) type tracking servo employing both a main push-pull (MPP) balance of an MPP signal and a side push-pull (SPP) balance of an SPP signal to control an SPP signal, the method comprising:
generating a signal to control a pickup to cross a track center of a track of a disc when a tracking servo is not performed; and
moving the pickup in response to the signal to cross the track center in a first direction and a second direction.

30. The method of claim 29, further comprising:
detecting the SSP signal when the pickup crosses the track center in response to the signal;
low-pass filtering the SSP signal to detect a direct current component; and
removing the direct current component from the SPP signal.

31. The method of claim 29, wherein the removing of the direct current component comprises:
generating a high frequency component from the SSP signal.

32. The method of claim 29, wherein the disc comprises a non-eccentric disc, and the low-pass filtering of the SSP signal comprises generating the direct current component without controlling a cut off frequency of a low pass filter low-pass filtering the SSP signal when the pickup moves along the track of the non-eccentric disc.

33. The method of claim 29, wherein the disc comprises a non-eccentric disc, and the generating of the signal comprises generating opposite polarity signals to control the pickup to cross the track center to forcibly generate eccentricity of the non-eccentric disc.
